(19) United States
(12) Patent Application Publication
(10) Pub. No.: US 2025/0050781 A1
(43) Pub. Date: Feb. 13, 2025

(54) SWAPPABLE MODULAR BATTERY AND ELECTRONIC SPEED CONTROLLER SYSTEM FOR ELECTRIC VEHICLES

(71) Applicant: LECTEC INC., Dover, DE (US)

(72) Inventor: Jared Ebersole, Catawissa, PA (US)

(21) Appl. No.: 18/781,261

(22) Filed: Jul. 23, 2024

Related U.S. Application Data
(63) Continuation-in-part of application No. 18/232,203, filed on Aug. 9, 2023.

(51) Int. Cl. B60L 53/80; B60L 15/20; H01M 10/42; H01M 50/233; H01M 50/244; H01M 50/249; H01M 50/502

(52) U.S. Cl. CPC B60L 53/80; B60L 15/20; H01M 10/425; H01M 50/233; H01M 50/244; H01M 50/249; H01M 50/502; B60L 2200/46; H01M 2010/4278

(57) ABSTRACT

The present invention relates to a modular system for electric vehicles that enhances adaptability and functionality through interchangeable modules. This invention provides a swappable data communication modular system that can be utilized on various types of electric vehicles, including electric skateboards, scooters, and bikes. The system includes a mounting system enabling the secure attachment and easy swapping of a variety of modular units. Each module is capable of independently sending and receiving data and power, facilitating sophisticated interactions such as power output adjustments based on battery conditions or customizing operational behaviors based on vehicle speed. The modular units are designed to be housed in cases to protect the internal components. This system promotes customization and innovation, allowing users to tailor electric vehicle functionalities to specific needs and transfer these capabilities between different vehicles, thereby enhancing the overall adaptability and potential applications of electric vehicles.

### CROSS-REFERENCE TO RELATED APPLICATIONS

The present invention is a continuation in part application to Ser. No. 18/232,203, filed Aug. 9, 2023, entitled “SWAPPABLE MODULAR BATTERY AND ELECTRONIC SPEED CONTROLLER SYSTEM FOR ELECTRIC VEHICLES” which is incorporated in its entirety, at least by reference.

### BACKGROUND OF THE INVENTION

### 1. Field of the Invention

The present invention relates to modular systems but more particularly a swappable data communication modular system for electric vehicles.

### 2. Description of Related Art

Electric vehicles (EVs) are increasingly popular across various transportation modes, including scooters, bicycles, go-karts, skateboards, boats, and even robotic platforms. Their appeal largely stems from environmental benefits, operational efficiency, quietness, and the convenience of home charging.

Despite these advantages, transitioning to electric power presents significant challenges, primarily due to the high costs associated with key electric vehicle components like batteries and electronic speed controllers (ESCs). The battery, as the primary power source, and the ESC, which regulates power distribution to the motor, are costly investments. This is the case for both new electric vehicle purchases and retrofitting existing vehicles with electric capabilities.

Moreover, the design of current electric vehicles lacks flexibility and customization. Batteries and ESCs are often integrated into the vehicle's architecture in a fixed manner, which complicates the process of swapping these components between different vehicles or modifying the vehicle's range and power to suit individual user needs. Furthermore, the customization options are typically limited to non-essential modifications, leaving little room for users to adapt core functionalities to specific applications or preferences.

Consequently, this invention addresses these limitations by introducing a modular system that includes swappable batteries, ESCs, and custom modules. This approach not only allows for easy interchangeability of essential power components across various electric vehicle platforms but also introduces custom modules that can be tailored for specific functions, enhancing the vehicle's capabilities and personalization. This system significantly enhances the flexibility and customization potential of electric vehicles, reducing barriers to adoption and allowing users to tailor their vehicles to specific needs and preferences.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a particular object of the present invention to provide swappable modular components, such as a battery, electronic speed controller system, programming module, or additional custom modules for electric vehicles designed to reduce costs, increase flexibility, provide customization, and make electric power more accessible for a wide range of vehicles. It is another object of the present invention to create a system where modules can be quickly connected or disconnected, such that users can easily transfer these components between different vehicles. This not only allows users to save money by using the same battery and ESC for multiple vehicles, but it also enables them to customize their vehicle's range and power by adding or removing battery modules as needed.

In order to do so, a modular data system for electric vehicles is provided, comprising a mounting system configured to removably attach a plurality of swappable modular units to an electric vehicle; wherein the plurality of swappable modular units include an electric speed controller (ESC), and at least one battery module; and wherein each of said swappable modular units is configured to independently send and receive data to and from any other swappable modular unit within the system via a module connection system, facilitating direct communication and interaction among all the plurality of swappable modular units.

In one embodiment, the mounting system is designed to allow for each modular unit to be swapped, facilitating quick changes and interchangeability between different electric vehicles. In one embodiment, the module connection system comprises a plurality of terminal pins, each configured to provide both data and power transfer capabilities. In another embodiment, each of the plurality of swappable modular units comprises a substantially rectangular case configured to house and protect internal components. In yet another embodiment, each of the plurality of swappable modular units comprises a set of the plurality of terminal pins on opposite sides of each swappable modular unit case, facilitating the connection with any adjacent modular units.

In one embodiment, further comprising at least one custom module is configurable to perform a variety of operational tasks based on input received from the environment of the electric vehicle, and is further capable of executing predetermined actions based on data signals sent from any swappable modular unit of the plurality of swappable modular units. In another embodiment, the at least one custom module is enabled to receive a programmable logic controller or computer device. In another embodiment, the variety of operational tasks include changing light conditions of an attached LED light strip or playing music from an attached speaker system. In one embodiment, the communication and interaction among the plurality of swappable modular units enables the at least one battery module and ESC to communicate such that the ESC is configured to adjust voltage drawn from the at least one battery module based on data signals sent from the at least one battery. In some embodiments, the electric vehicle is a skateboard, and the mounting system is fastened to an underside of the skateboard's deck.

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a bottom perspective view of a swappable data communication modular system for electric vehicles according to an embodiment of the present invention.

FIG. 2 is a detailed view of Detail 2 in FIG. 1 showing a module connection system according to an embodiment of the present invention.

FIG. 3 is a bottom perspective view of a custom module according to an embodiment of the present invention.

FIG. 4 is a perspective view of an additional custom module according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a swappable data communication modular system for electric vehicles.

It is to be understood that the terminology used herein is for the purpose of describing particular embodiments only and is not intended to be limiting. The terms “a” or “an,” as used herein, are defined to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

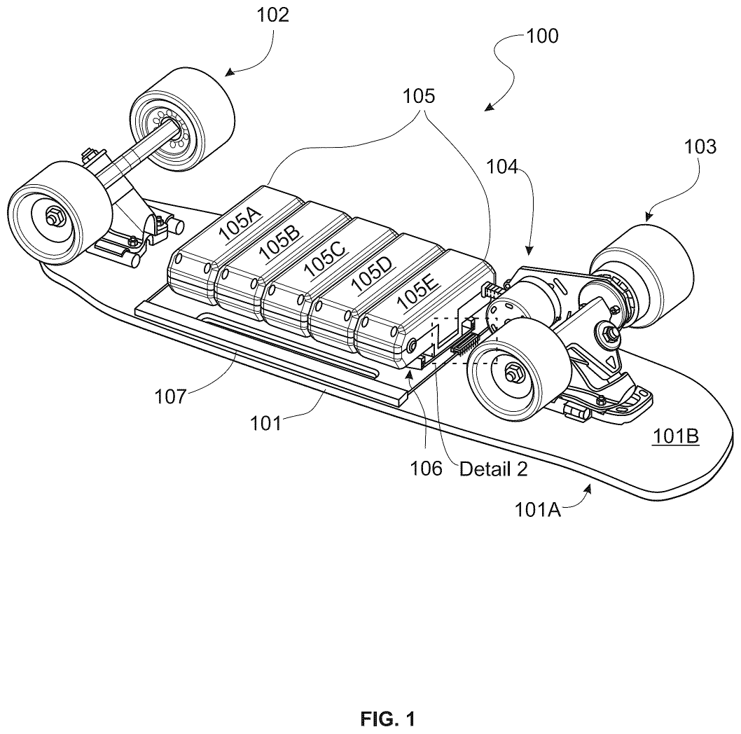

FIG. 1 is a bottom perspective view of a swappable data communication modular system for electric vehicles according to an embodiment of the present invention. Referring to FIG. 1, in one embodiment, the system 100 includes an electric vehicle, such as a skateboard. The skateboard comprises a deck 101 having an underside 101B, and a topside 101A which is configured to receive the feet of a rider as well known in the art. As with traditional electric vehicles and skateboards, the system of the present invention includes a pair of wheel assemblies 102 and 103, with an electric motor 104 configured to rotate one or more wheels of wheel assembly 103. In the exemplary example shown, each wheel assembly features wheels, bearings, skateboard trucks, and optional spacers configured to increase the clearance of skateboard as well known in the art. For the sake of this disclosure, the general function and operation of the skateboard components and electric motor is well known and outside the scope of the present invention. Rather, the present invention focuses on the swappable data communication modular system which may be utilized on any electric vehicle, including but not limited to electric skateboards, electric scooters, electric bikes, and similar transportation vehicles.

Still referring to FIG. 1, in some embodiments, the swappable data communication modular system 100 for electric vehicles comprises a number of swappable modular units 105 configured to attach into a mounting system 106 via sliding, snapping, or similar connection methods. The mounting system will be discussed in further detail below. Advantageously, the specific type of swappable modular units 105 may vary. However, all systems will at least have a modular electric speed controller (ESC) 105E, and at least one modular battery unit, in this example indicated as 105C and 105D in FIG. 1. Swappable modular units 105A and 105B may be any custom module desired by the user. In this specific illustrated embodiment, 105A is a hydraulic control module, and 105B is a programming module, however these are just examples and one skilled in the art would understand the capabilities and potential modules that may be utilized in the system of the present invention. Further, the number of swappable modular units 105 may vary.

Advantageously, the system of the present invention allows for each module to independently send and receive data, as well as power, which enables sophisticated interactions between each modular unit. As an example, in one embodiment, at least one battery module is enabled to detect a low voltage condition and signal to the ESC to limit power output. In another example, the ESC is enabled to trigger changes in a LED light bar 107 based on the electrical vehicle's speed, wherein the LED lights may change colors based on the current speed, such as blue or green when exceeding five miles per hour.

As previously mentioned, the system includes the use of custom modules outside of the necessary ESC and battery modules. For example, the programming module 105B is configured to facilitate custom functionalities for a variety of features, which may control additional modules, such as a hydraulic control module 105A for advanced mechanical operations. This system provides endless capabilities, including AI (artificial intelligence) modules that may be configured to provide automation and intelligent responses in relation to vehicle conditions as well as interacting with the other connected modules. Furthermore, the system enables users to develop custom modules. These user-created modules can interface with the system, receiving data from existing modules, performing specific actions based on that data, and transmitting their own data to influence the behavior of other modules. Advantageously, this feature supports a high degree of customization and innovation, enabling tailored solutions to meet diverse user requirements. Each module is swappable which allows the user to change the features of the electric vehicle and swap the modules between electric vehicles as well enhancing the system's adaptability and potential applications.

In one embodiment, each of the number of modular units 105 comprise a case that is generally rectangular in shape and constructed of any material or combination of materials suitable for housing battery, electrical, mechanical, and/or hydraulic, wherein the case material may include but is not limited to plastics, thermoplastics, and metals such as aluminum or stainless steel, as well as composite materials such as fiber composites. Further, the case may be transparent allowing the user to view the internals of each module.

In some embodiments, each modular electric battery unit is a lithium-ion battery. In other embodiments, each modular electric battery unit is a nickel-metal hydride battery. Yet in other embodiments, each modular electric battery unit may be any type of rechargeable battery suitable for powering the various electric vehicles. As is well known in the art, the number of batteries and the power (W) and capacity (Wh) of each battery dictate the overall performance of the vehicle, in terms of power and range, respectively. Advantageously, the present invention's system enables a user to add a desired number of modular battery units, each potentially having varied power and/or capacity.

As known in the art, the electric speed controller (ESC) is configured to serve as the intermediary between the battery and the motor. The ESC regulates the power drawn from the modular battery units and directs it to the motor, effectively controlling the speed of the electric vehicle via a remote, controller, or throttle (not illustrated).

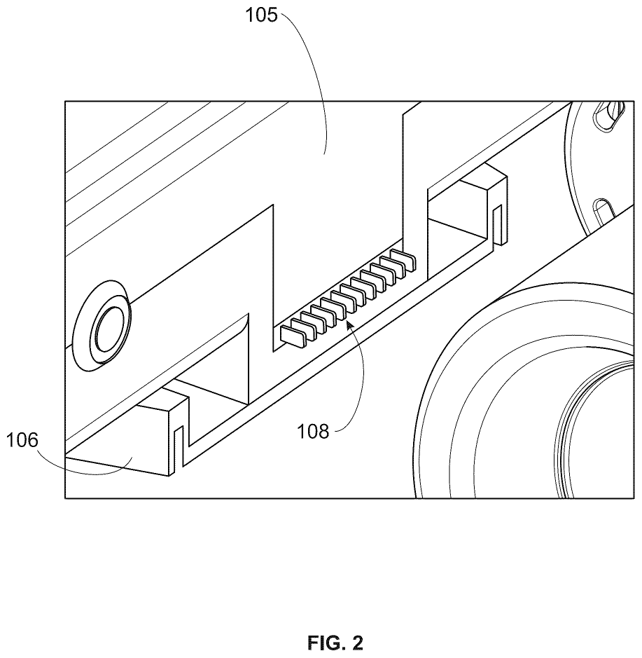

FIG. 2 is a detailed view of Detail 2 in FIG. 1 showing a module connection system according to an embodiment of the present invention. Referring now to FIG. 2, each modular unit of the number of modular units 105 comprises a module connection system 108 having a number of terminal pins configured to transfer data and power between modules. It is critical that the number of terminal pins is sufficient for both data and power transfer.

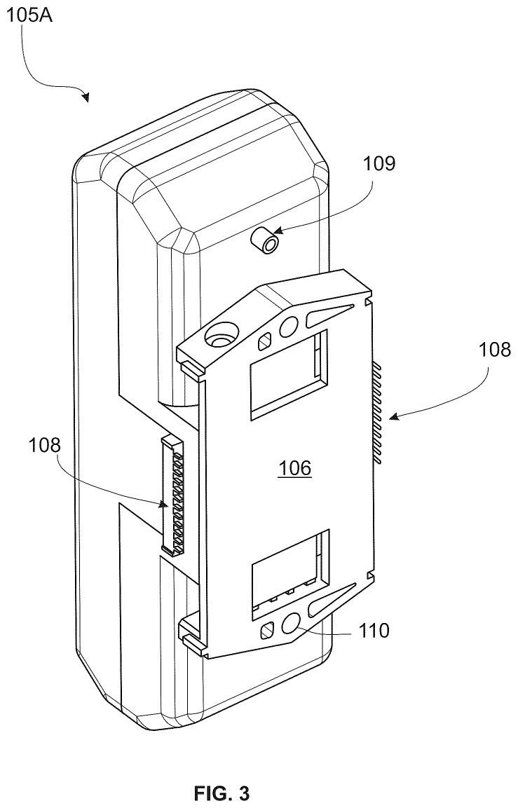

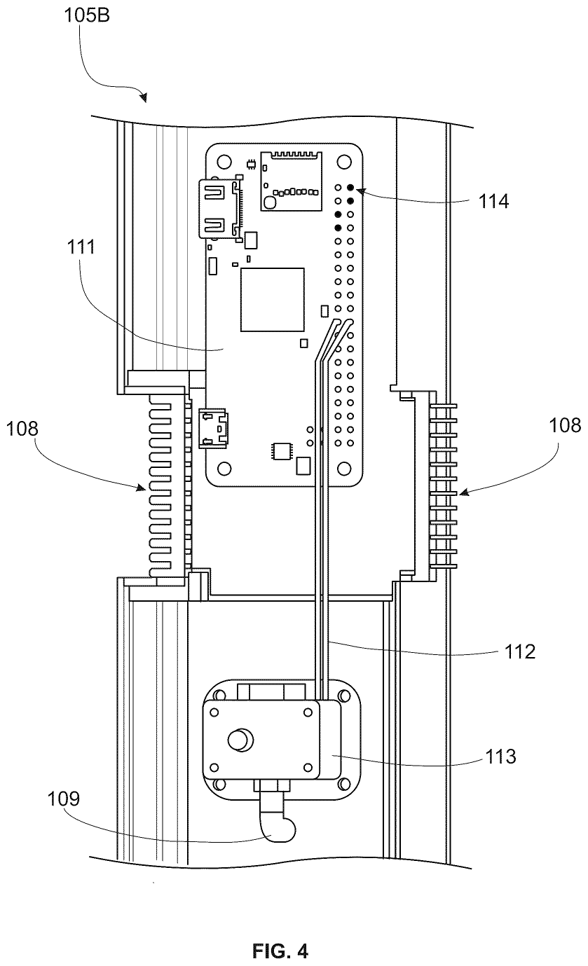

FIG. 3 is a bottom perspective view of a custom module according to an embodiment of the present invention. Referring now to FIG. 3, the specific swappable modular unit illustrated is a custom module, which is a hydraulic control module 105A in this specific example. The following is an example of one custom module, however it is understood that many different modules may be implemented. In one embodiment, the hydraulic control module 105A comprises a hydraulic conduit 109 positioned within the case of the module unit in communication with a hydraulic source, such as a hydraulic cylinder/piston, hydraulic pump, or similar system, wherein the hydraulic conduit extends beyond the case such that a connection with a hydraulic arm (not illustrated) is possible. This could facilitate a robotic arm that would be configured to do a number of tasks. In some embodiments, a programming module may be used to control the hydraulic system and hydraulic arm, such as the swappable programming module 105B shown in FIG. 1, or alternatively the programming module may be combined with the hydraulic module as one singular modular unit (as shown in FIG. 4). Also visible in FIG. 3, is the mounting system 106 which is configured to attach and be secured to the electric vehicle such that mounting the number of swappable modular units is possible. As previously mentioned, the exact specification and operation of the mounting system 106 may vary, however the mounting system should adequately provide ease of swapping modules, i.e. be removable and easy to install. Further, each mounting unit of the system is configured to be able to mount one swappable module, such that the number of mounting units of the system depends on the number of swappable modules provided.

In one embodiment, each mounting unit of the mounting system is attached to the bottom surface of the skateboard deck or other suitable location on each electric vehicle, such as a vehicle frame. The number of mounting units may also exceed the number of modular units such that future modular units may be installed if desired, while also allowing users to swap modular units between a number of electric vehicles as previously discussed.

Advantageously, all modular units are removably attached to the mounting system 106. Tabs, guides, or other similar features may be used to facilitate the attachment, connection, sliding, etc. of each modular unit within the mounting system. In some embodiments, the module connection system, i.e. terminal pins may be provided on each mounting unit or alternatively be attached to each modular unit to facilitate the connection between units.

Each mounting unit comprises holes, shown by example as 110, wherein the holes enable the connection and attachment to the electric vehicle. Each modular mounting unit element is configured to stack horizontally adjacent to another modular unit. In alternative embodiments, each modular mounting unit is shaped to nest within an adjacent unit such that the nesting or stacking of adjacent units creates a singular mounting system that is seamless between each mounting unit. It should be understood that various attachment mechanisms and technologies may be used to secure each modular unit to the modular mounting unit system, including but not limited to the use of magnetic connections, tabs, stops, quick release pins, and other removal or temporary attachment or securement methods.

During use, to attach a modular unit to the electric vehicle, such as a modular battery unit or modular ESC, or custom module, the user aligns a swappable modular unit within the mounting system to secure it in place via a connection method as discussed previously. During use, to remove the one or more modular units, the user simply reverses the attachment process. They disengage the securement element, if present, and then slide or remove the desired number of modular units out from the modular mounting system. This process allows for quick and easy swapping of units, enabling users to customize their electric vehicle setup or transfer units between different vehicles with minimal effort.

FIG. 4 is an exposed view of the custom module of FIG. 3 with a portion of the case removed such that the internals are viewable. As previously mentioned, a programming module may be configured to control other swappable module units, features within the same modular unit, or any other module including the battery modules and ESC modules. As an example, as previously mentioned, the LED lights (107;FIG. 1) may change colors based on the current speed, such as blue or green when exceeding five miles per hour. In one embodiment, the programming module 105B may comprise a computer device 111, such as a Raspberry Pi or Ardunio, which functions as a programmable logic controller configurable to read data signals sent, and execute code when certain conditions are met, such as changing the LED lights or playing audio via a speaker when a certain speed is reached by the electric vehicle. Back to the illustrated example, the computer device 111 is configured to send and receive data/power to a hydraulic pump 113 which is in communication with a hydraulic line 109 configured to extend outside the case to control a hydraulic component, such as a robotic arm as previously described.

To provide an ideal level of customization for the user, each custom module may include wiring 114, studs, connections or similar configured to connect the module to a computer device, wherein the wiring 114 forms a connection with the module connection system 108 such that the custom module is enabled to connect with other connected modules. As one skilled in the art would appreciate, the present invention provides an adaptable modular system capable of custom functions, enabling users endless opportunities to customize their electric vehicles capabilities, and then transfer those capabilities to additional electrical vehicles, without the expense of having duplicate modular units.

Although the invention has been described in considerable detail in language specific to structural features, it is to be understood that the invention defined in the appended claims is not necessarily limited to the specific features described. Rather, the specific features are disclosed as exemplary forms of implementing the claimed invention. In other words, the terminology and phraseology used in this description and the abstract are for illustrative purposes and should not be considered as limiting. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so forth members throughout the disclosure (and in particular, claims) are not used to show a serial or numerical limitation but instead are used to distinguish or identify the various members of the group.

What is claimed is:

1. A modular data system for electric vehicles, comprising:
a mounting system configured to removably attach a plurality of swappable modular units to an electric vehicle;
wherein the plurality of swappable modular units include an electric speed controller (ESC), and at least one battery module; and
wherein each of said swappable modular units is configured to independently send and receive data to and from any other swappable modular unit within the system via a module connection system, facilitating direct communication and interaction among all the plurality of swappable modular units.

2. The modular data system of claim 1, the mounting system is designed to allow for each modular unit to be swapped, facilitating quick changes and interchangeability between different electric vehicles.

3. The modular data system of claim 1, the module connection system comprises a plurality of terminal pins, each configured to provide both data and power transfer capabilities.

4. The modular data system of claim 1, wherein each of the plurality of swappable modular units comprises a substantially rectangular case configured to house and protect internal components.

5. The modular data system of claim 4, wherein each of the plurality of swappable modular units comprises a set of the plurality of terminal pins on opposite sides of each swappable modular unit case, facilitating the connection with any adjacent modular units.

6. The modular data system of claim 1, further comprising at least one custom module that is configurable to perform a variety of operational tasks based on input received from the environment of the electric vehicle, and is further capable of executing predetermined actions based on data signals sent from any swappable modular unit of the plurality of swappable modular units.

7. The modular data system of claim 6, wherein the at least one custom module is enabled to receive a programmable logic controller or computer device.

8. The modular data system of claim 7, wherein the variety of operational tasks include changing light conditions of an attached LED light strip or playing music from an attached speaker system.

9. The modular data system of claim 1, wherein the communication and interaction among the plurality of swappable modular units enables the at least one battery module and ESC to communicate such that the ESC is configured to adjust voltage drawn from the at least one battery module based on data signals sent from the at least one battery.

10. The modular data system of claim 1, wherein the electric vehicle is a skateboard, and the mounting system is fastened to an underside of the skateboard's deck.
